(19) United States
(12) Patent Application Publication
(10) Pub. No.: US 2003/0120676 A1
(43) Pub. Date: Jun. 26, 2003

(54) Methods and apparatus for pass-through data block movement with virtual storage appliances

(75) Inventors: Adarsh Holavanahalli, Jayanagar (IN); Phani Talluri, Andhra Pradesh (IN); Varaprasad Lingutla, Sunnyvale, CA (US); Chandrasekhar Pulamarasetti, Vepagunta (IN); Rajasekhar Vonna, Andhra Pradesh (IN); Vinayaga Raman, Alwarpet (IN); Lakshman Narayanaswamy, Santa Clara, CA (US); Srinivas Pothapragada, Jayanagar (IN)

Correspondence Address: WILSON SONSINI GOODRICH & ROSATI, 650 PAGE MILL ROAD, PALO ALTO, CA, 943041050

(73) Assignee: Sanrise Group, Inc.

(21) Appl. No.: 10/026,668

(22) Filed: Dec. 21, 2001

(51) Int. Cl. G06F 7/00

(52) U.S. Cl. 707/102

(57) ABSTRACT

A virtual storage appliance (VSA), acting as a target tape library emulating multiple tape drives. The overhead in processing the data within the VSA and the command blocks can be reduced by utilizing in-memory buffers as a pass-through to a storage media such as a target tape library. The VSA may function as a target device relative to a network server for use as a backup tape library. Furthermore, the VSA may include interface (which can be any interconnect interface like SCSI or FC) and buffers in the memory along with the command blocks which points to these buffers. The data that comes in from an initiator server is written onto a disk storage system. However, the same data buffers that are in the memory in the VSA can also be used to spool the data onto the tape library to eliminate further disk and file system overhead. The same in-memory buffer can now be used by the VSA that will act as an initiator to write to the target tape library. Further, the file system on the disk storage subsystem in the VSA can be a sequential file system to reduce the overhead caused due to randomness and block allocation methods of a traditional file system.

### FIELD OF THE INVENTION

The invention relates generally to computer systems, and more particularly, to buffering techniques and apparatus for expediting the transfer of data between a computer and an external data storage source or destination.

### BACKGROUND OF INVENTION

The archival of data has been a very important part of the evolution of information technology. The availability of archival resources has been critical for enabling business to perform a variety of functions ranging from retrieval of data during possible disaster recovery efforts to controlling enterprise version control or data change management. Traditional forms of archival resources that are available include hard copies of documents or data, magnetic tapes, optical disk drives, CD-ROMs, floppy disks and direct-access storage devices (DASDs).

The archival process if often perceived as a necessary standalone process which consumes valuable time and resources. Similarly the recovery process of information from archival sources presents the same challenges. Over the recent years, archival sources such as tape drives and other forms of backup medium have become grew faster and provide more compact or denser forms of data storage. But even with these advancements, the current data storage solutions of today are lagging behind in the growth of the volume of data that must be managed. Typical network environments include server computers to manage data storage resources such as DASDs which contain data that is required or written by an application executing in a client computer. Even if the amount of data transferred in networks is extensive, it is important to expedite the rate of data transfer during the archival and retrieval processes. Accordingly, the archival of data onto DASD and other storage devices has become increasingly popular, and thus evolved storage solutions such as the virtual tape server (VTS).

Many publications are available describing the operation and architecture of virtual tape systems, including U.S. Pat. No. 6,282,609 (Carlson) and U.S. Pat. No. 6,023,709, which are herein incorporated by reference in their entirety. In general, a VTS projects itself as a tape device to network servers and store the data that is being sent to them on resources such as DASD to accelerate the archival process. These devices then transfer the data from the DASD storage in accordance with established policies and protocols prior to subsequent transfer to a typically less-expensive secondary storage medium such as tape drives, magneto optical drives, CD-ROMs, etc.

A variety of techniques that are available today enable faster data retrieval from archives by storing the entire portion of data or a portion thereof on a DASD for an extended time beyond its archival. However, during the time when the data is stored on DASD within a virtual tape system, a tape drive is typically idle or it may be used to spool the incoming data at a lower speed. In instances where the data is spooled onto a tape drive on the backend, this intelligent pre-processing places a costly burden on the DASD cache, the system processor and interface of the VTS system, which further serves as the target system for network servers. The incoming data is often copied several times into multiple data buffers within the cache memory since the interfaces on which data is coming in and going out are different within the VTS system. Moreover, current VTS systems depend on their native file system to store the archival data. Due to the wide range and often random selection of other available file systems, it is often inefficient to store sequentially formatted data on selected VTS file systems.

### BRIEF SUMMARY OF THE INVENTION

The present invention provides various methods and apparatus for accelerating data transfer and storage activities using network appliances or computers. Data transfer activities may be managed and directed expeditiously in accordance with the invention for effective the archival of data, replication of data, or data retrieval.

An object of the invention is to provide data storage methods and apparatus that incorporates a zero-copy buffering mechanism to store and directly move data from the volatile memory of a computer or virtual storage appliance (VSA) to a non-volatile memory storage resource. The store and forward mechanisms provided herein may selectively transfer incoming data to a storage resource with or without pre-processing. The non-volatile storage of data may also include a file system that is either capable of random data storage and retrieval, or alternatively, both random and sequential data storage and retrieval.

Another object of the invention is to substantially eliminate the need for copying the data into different data buffers within cache memory when the data that is coming into the target system from a network server. In particular, when data is transferred from the server to a target system, which may be in this case a VSA, it is landed into selected data buffers within the cache which are also used by the interface hardware. Typically, a command descriptor block (CDB) contains pointers to these data buffers. When the VSA is selected as a target device for the server that is archiving its data, the CDB in the VSA points to the data that has been received from the server. When the VSA in turn is writing the data from non volatile memory onto a secondary storage device, it will use the same data buffer. No additional data replication is required within memory. The data buffers may be also used by a sequential file system to write it to the storage medium in the VSA.

Accordingly, an object of the present invention is to expedite the rate of data transfer between a network storage appliance or computer to other secondary storage devices.

### BRIEF DESCRIPTION OF THE DRAWINGS

FIG. 1 illustrates the overall architecture of storage network system with virtual storage appliances located at the primary and secondary locations.

FIG. 2 is a general diagram illustrating the pass-through data block movement which may be achieved in accordance with the invention.

FIG. 3 illustrates the data pointer passing process within the random access memory of a VSA.

FIG. 4 illustrates the pass-through data block movement within defined kernel memory and user memory components of a computer memory.

### DETAILED DESCRIPTION OF THE INVENTION

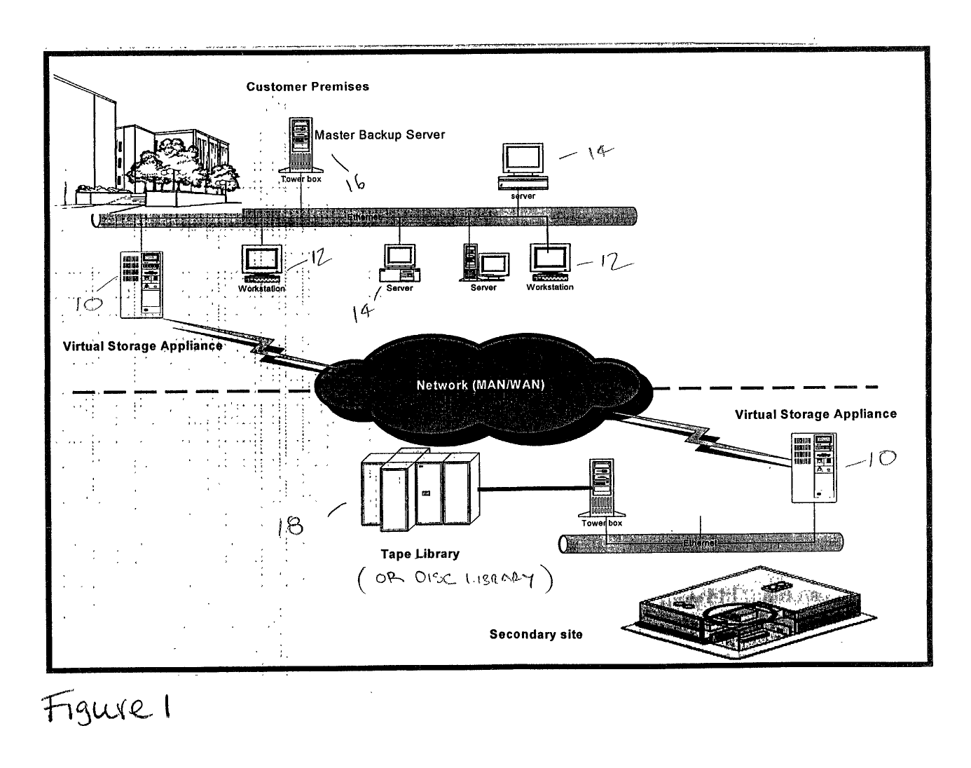

Referring now to FIG. 1, a storage network solution architecture is provided which may incorporate various aspects of the invention described herein. A virtual storage appliance (VSA) 10 facilitates both the local archival of data at a primary location and its transfer remotely from customer premises to a secondary site or remote location. A plurality of local area network (LANs) such as an Ethernets and Fibre Channel networks may be established and interconnected to form a storage network. Within each LAN, a VSA 10 may reside on the network to facilitate the transport of archival data. At the customer premises, the architecture of the backup solution may include various workstations 12 and servers 14 including a master backup server 16 or towerbox which may assist managing the frequency or backup process for the customer premises site. At a secondary site, the actual data storage may be accomplished wherein archival data is transferred transparently over a network onto one or more tape libraries 18. As with certain known VTS systems, this migration of data may not be apparent at all when requesting archived data. But tape libraries or other secondary storage devices do not necessarily reside on the customer premises and may be located off-site. It shall be understood that multiple customer or storage sites may be connected via the described storage network.

The application of VSAs described herein provide a flexible approach to data storage and servicing. A VSA can route data to specific media and locations depending on configurable policies rather than simply storing each customer's data on separate backup tapes (like existing IBM tape backup systems). The VSA architecture provides a modular, scalable, customized, and dynamic solution which utilizes concepts of load balancing across various storage devices including high capacity disks (as opposed to utilizing only tapes as shown) to provide storage and other data services that adapts to the unique needs of a particular customer. The storage devices provide herein offer flexibility and high capacity different from traditional tape library solutions. The VSA system emulates a tape interface to the customers server being backed up while utilizing software to optimize the allocation of storage resources on a variety of media which may not be apparent to a customer, including networked storage disks. Additionally, the VSA architecture may utilize a file system that transfers data serially (as opposed to the random allocation of data blocks on disks), thus allowing multiple data streams to be transferred at once-a process that may occur in parallel on numerous disks.

A storage area network may be provided in accordance with invention that backs up data using multiple VSAs and storage devices, including a disk and a tape drive or library. Control software residing on a VSA may determine where and how to store data depending on customer preferences and principles of optimal resource allocation (e.g., cost, space, equipment required). The VSA systems provided herein enable storage and servicing of data at different physical locations or on different media depending on the characteristics or policies of a particular customer or the characteristics of particular data. Moreover, particular “rules” may be established that recur frequently and govern the distribution of data among the various storage units based on date of last access or other selected criteria.

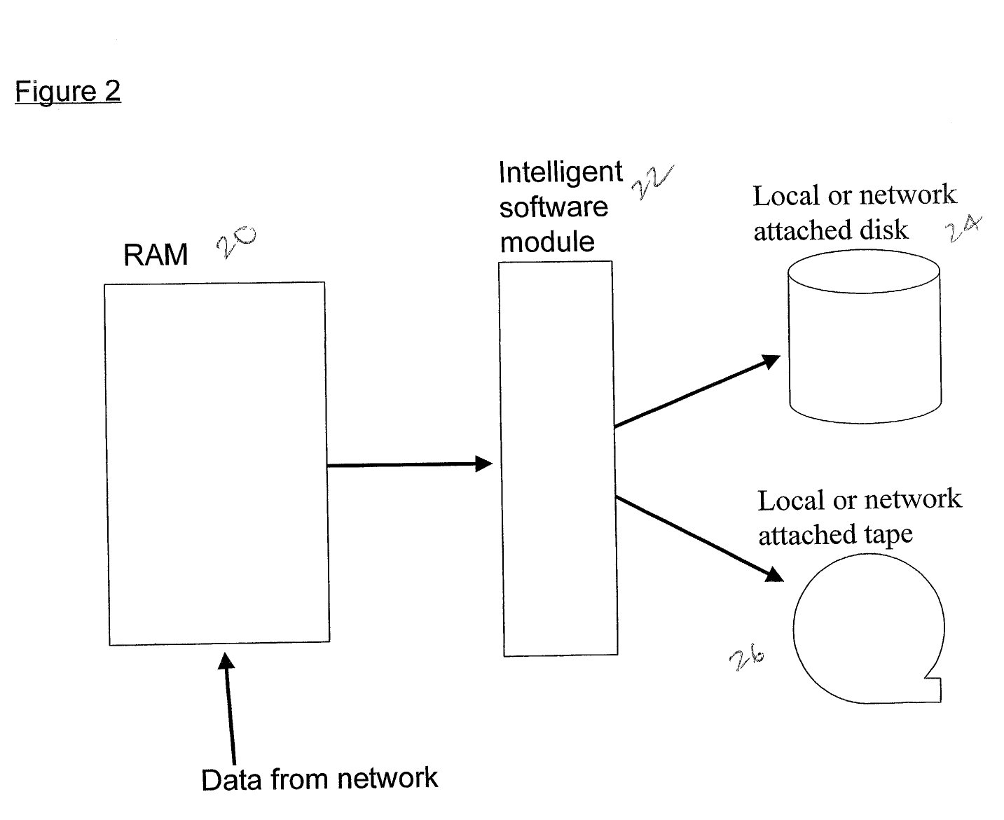

As shown in FIG. 2, the random access memory (RAM) 20 of a VSA may receive incoming data from the network or fabric. The incoming data may originate from a variety of network locations including a remote location on the network such as a customer premises. The data to be stored and or processed lands into a discrete data buffer within cache memory. A command descriptor block (CDB) within the VSA may provide pointers or locators to these data buffers. Rather than replicating a particular data buffer within memory multiple times, the corresponding pointer to this data or control data is passed along whenever reference is made to the data buffer or when such data is to be further processed. The data pointers may be referred to when processing the data within the VSA with various intelligent software modules 22 for data compression, encryption or other applications described herein. Furthermore, the same data is used when written onto a secondary storage device such as a disk 24 or tape 26 libraries. It shall be understood that the data may be sent directly to the secondary storage resources directly without any additional processing by intelligent software modules. The data may be of course directed to various locations within the network or stored within the memory of the VSA itself. In any event, with the use of data pointers described herein, no additional data replication is required within the memory. The same data buffer will be used whether the data is sent to other storage devices such as disks or tape resources that may be local or attached elsewhere on the network.

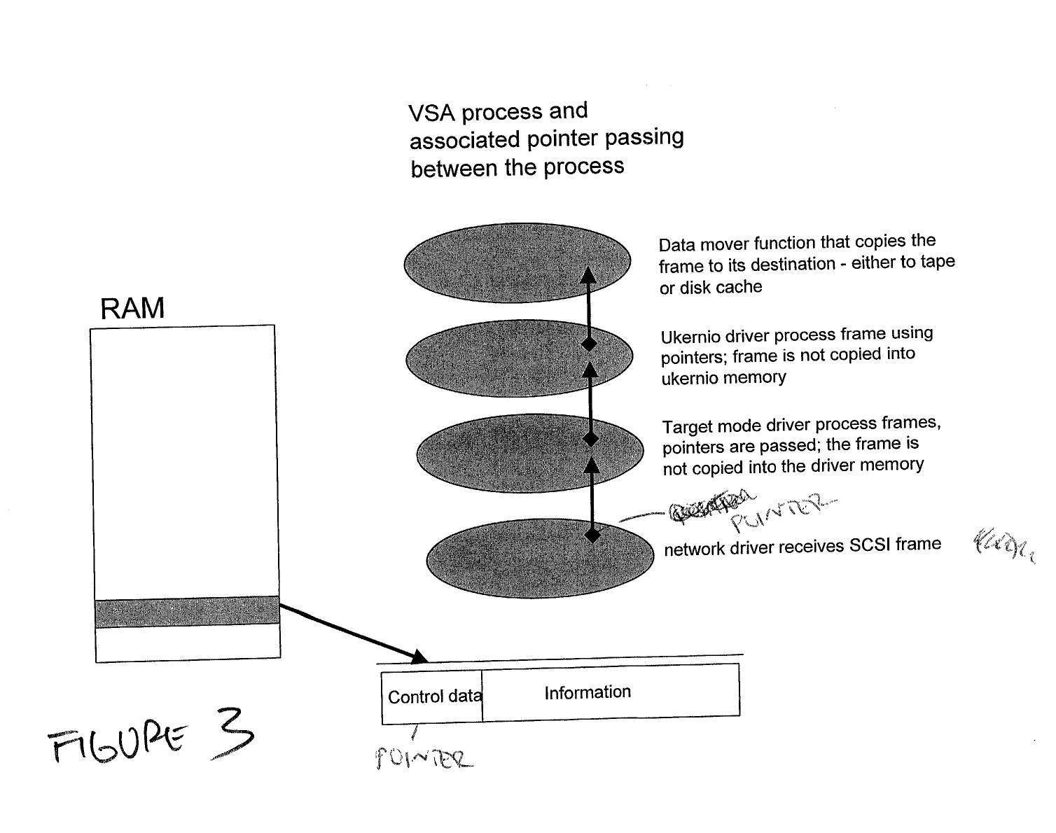

Data pointer movement within the VSA system provided herein is further illustrated in FIG. 3. Each volume or frame of data copied and stored within the RAM of a VSA may be described as having two basic components: control data and information. The control data or pointer uniquely identifies a particular data frame, and acts as an identifier for the data frame that is passed between various processing. The underlying information corresponding to the control data is not copied into different portions of memory in accordance with the zero-copying buffering technique described herein. For example, a network driver may receive data frames or a SCSI command from the network or fabric. A target mode driver may process the frames by passing along the data pointers but not copying the information or entire data frame into the driver memory. Next a UKERNIO driver may process data frames using the pointers again as a reference rather than copying the data frames entirely into UKERNIO memory. As certain processes are carried out within the VSA systems described herein, multiple copying of identical data frames are minimized or avoided altogether. Finally when data movement occurs upon completion of selected processing, the data frames are copied towards a desired storage destination such as the cache of a tape or disk source.

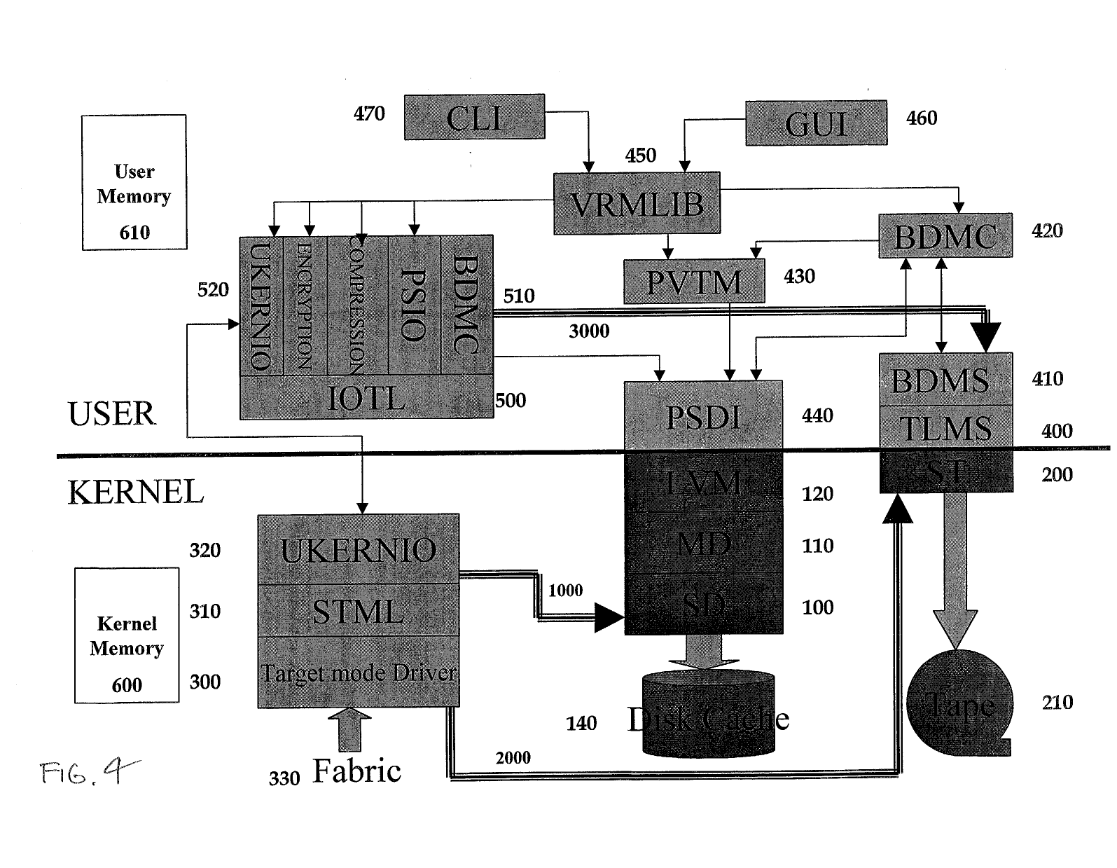

FIG. 4 further illustrates the RAM component within a VSA or similar network computer provided in accordance with the concepts of the invention. A virtual resource manager (VRM) 450 may be selected to operate as a management interface in order to administer a VSA. This may consist of a management application program interface (API) and a command line interface (CLI) 470 that may be developed using the same API. A graphical user interface (GUI) 460 may also use the same API. Furthermore, one or more central processing units (not shown) may access the RAM which may be running a kernel module. The memory space of the system may be conceptually or operatively divided into two components: the user memory space 610 and the kernel memory space 600. A data transfer request may be received by the system either through the network directly or through a target mode driver 300. The request may reside in a kernel memory 600 as directed by the target mode driver 300. The incoming data transfer request may include a SCSI command with the accompanying data to be transferred. A pointer for this location in the kernel memory, where the request is transferred to by the target mode driver 300, may be directed to the upper layers using messages The target-mode driver 300 may be a Fibrechannel HBA (Qlogic ISP 2200) driver, which receives SCSI requests and sends SCSI responses over a FibreChannel interface and may further include features such as LUN-masking. The SCSI Target Mid-level Layer (STML) 310 processes SCSI commands that are received, passes such commands to selected target devices, and maps the response to the request, while replying. This enables the system to map virtual devices to physical target devices, which can be remote or local.

Next in the VSA process, the UKERNIO module may process a data transfer request with its corresponding pointer without replicating the data in memory. The UKERNIO may be seen as the component that brings together or links the user-level modules and kernel-level modules within the memory of a VSA. The kernel level UKERNIO component 320 exports device interface for administration. And together with the user-level UKERNIO 520, both provide a transparent interface to user-level streams modules. The kernel side of the UKERNIO 320 provides stream level mapping and administration for the data to flow through the VSA. The user UKERNIO 520 maps the data streams when instructed to run through various processing with intelligent software modules like compression, encoding, etc. The VSA can thus accomplish additional processing on the data associated with the incoming request on demand. Furthermore, the I/O Transliterator Stream (IOTL) 500 is a user-level streams framework that allows different I/O processing modules to be pushed into the stream based on a configuration. Each tape drive or disk cache may corresponds to a stream instance.

As illustrated in FIG. 4, individual paths 1000, 2000 and 3000 are possible paths of data transfer or movement that can be achieved by the invention. For example, path 1000 traces the data coming in from the kernel UKERNIO module 320. At this point, data has come in from the fabric and the SCSI request reaches the UKERNIO 320 module. When the kernel UKERNIO 320 receives a request, an intelligent decision can be made with respect to data flow control whereby the data may be selectively directed and written directly to the disk cache 140 using the path 1000. As a result, the data can land in the memory 600 only once, and the pointer to this data may be sent to the disk driver 100 which will in turn write the data to the disk. In other words, the data between the network memory buffer and the kernel UKERNIO 320 may be passed using pointers without again copying the data. Based on the incoming request and other pre-programmed information, the request may be transferred directly to the disk driver 100. Data however is not copied into the SD module 100 memory, rather data pointers are passed instead to the SD module. Data may be subsequently copied from RAM memory onto hard disk. The direct copying mechanism provided herein by-passes several layers of intelligence and thus provides a highly coordinated level of intelligence between all the modules that have been by-passed.

The zero-copying methods provided herein may further include a persistent meta store (PIM) which may be considered a disk cache management component consisting of three (3) modules: a PIM storage device insulation (PSDI) layer 440 which hides the storage/filesystem dependencies; a PIM virtual tape manager (PVTM) 430 which provides a tape management interface to create, delete virtual tapes on the disk cache; and a PIM streams IO (PSIO) module which provides a streams interface into disk cache so that an emulator can access the disk cache. The PSDI 440 module may possess the pre-allocated location in the disk cache through the pointer or the data meta data, as to where the corresponding data resides, and may have the same locator information as the kernel UKERNIO module 320.

Alternatively path 2000 traces a data path between the target mode driver 300 and the tape driver 200. In this pass-through mode, the data coming off the network can be directly copied onto a tape media 210. Path 2000 effectively by-passes the copying of data through several layers of the kernel. There exist intelligence amongst the modules that coordinate where the data has to be written. For a direct data transfer to happen from the target mode driver 300 to the tape driver 200, the target mode driver is instructed as to which tape drive to write the data. This selection process and intelligence may be coordinated between the UKERNIO, the VRM and BDM modules (described further below). The data may then written onto the tape drive 210 using the driver 200 on path 2000. The same data in the kernel memory is used without replication by passing along a data pointer to this data onto the tape driver 200 which will write the data to tape 210. Additionally a tape library management software (TLMS)400 may provide an interface to copy data onto physical tapes, and to restore the data from the same sources. The TLMS may function as a backup software with relatively minimal functionality.

Path 3000 traces yet another pass-through data path whereby data pointers or control information can move through various modules to transfer data from the kernel memory 600 onto the block data mover module. In this data movement path, the kernel UKERNIO 320 module passes control information or data pointers onto the user UKERNIO 520. The underlying data may be further processed if desired by compression and/or encryption modules. The permanent store module (PSIO) can make a decision as to the destination of the data based on set policies from the VRMLIB 450 module. Moreover, a block data mover server (BDMS) 410 may be selected to serve as a data migration module for migrating data from a disk cache onto a local or remote VSA, physical tape or storage device. The BDM modules may include a client and a server component. A block data mover client (BDMC) 510 can synchronously pass the data to a BDMS 410, the server side of the mover. This mechanism provides a pass-through mechanism where the pointer to the data that was in kernel memory 600, is directly passed to the BDMS 410 so that the data is not copied or duplicated within the system and is sent to the tape storage directly following the singular path 3000 illustrated in FIG. 3. As a result, the control information and data pointers are passed to the BDMC 510 which then communicates with the BDMS 410 module. The data can be copied to either a local or a remote subsystem via the BDM modules. If a local copy is desired then that data is moved only once, or alternatively, the data may be copied to a remote location by moving it to the BDMS 410 which transfers the data to the remote location over a network as described herein.

Based on the foregoing, various pass-through data block movement techniques are provided in accordance with various aspects of the present invention. While the present invention has been described in this disclosure as set forth above, it shall be understood that numerous modifications and substitutions can be made without deviating from the true scope of the present invention as would be understood by those skilled in the art. Therefore, the present invention has been disclosed by way of illustration and not limitation, and reference should be made to the following claims to determine the scope of the present invention.

What is claimed is:

1. A method for pass-through data block movement within a virtual storage appliance comprising the following steps of:
selecting a virtual storage appliance (VSA) with a microprocessor and random access memory (RAM) for receiving a data volume from a network interconnect;
storing the data volume within an allocated data buffer portion of the RAM;
assigning a unique data pointer corresponding to the data volume;
passing the data pointer onto a storage target device driver in communication with a non-volatile storage media; and
copying the data volume directly onto the non-volatile storage media from RAM which corresponds to the data pointer that is passed onto the storage device driver without further replication of the data volume within the RAM.

2. The method as recited in claim 1, wherein the target device driver is for at least one of the following target devices such as a switch, a tape library, a disk subsystem.

3. The method as recited in claim 1, where the non-volatile storage media includes a sequential file system.

4. The method as recited in claim 1, where the network interconnect is selected from at least one of the following: a parallel BUS, a SCSI, a Fibre Channel.

5. The method as recited in claim 4, where the interface can be a host bus adapter or a backplane that is either switched or a bus based architecture.

6. The method as recited in claim 1 wherein a plurality of data buffer portions can be used in sequence or in parallel to write to at least one storage target device.

7. The method as recited in claim 1 where the non-volatile storage subsystem includes at least a disk, a backed-up battery, a RAM, or a solid-state memory device.

8. A tape emulation method of zero-copying network data onto a tape drive system comprising the following steps:
selecting a computer with random access memory (RAM) and a target mode driver for receiving incoming data from a network;
storing the data within a buffer within RAM and assigning a data pointer for the data;
passing the data pointer from the target mode driver to a tape driver in communication with a tape library; and
moving the data from the RAM buffer directly into the tape library by identifying the data within RAM with the data pointer corresponding to the data without further replication within RAM.
